(19) United States
(12) Patent Application Publication
(10) Pub. No.: US 2009/0220788 A1
(43) Pub. Date: Sep. 3, 2009

(54) METHOD FOR SYNTHESIZING ULTRAHIGH-PURITY SILICON CARBIDE

(75) Inventors: Donovan L. Barrett, Port Orange, FL (US); Jihong Chen, Cincinnati, OH (US); Richard H. Hopkins, Export, PA (US); Carl J. Johnson, Gibsonia, PA (US)

Correspondence Address: THE WEBB LAW FIRM, P.C., 700 KOPPERS BUILDING, 436 SEVENTH AVENUE, PITTSBURGH, PA, 15219, US

(73) Assignee: II-VI INCORPORATED, Saxonburg, PA (US)

(21) Appl. No.: 12/096,306

(22) PCT Filed: Dec. 7, 2006
(86) PCT No.: PCT/US2006/046673

§ 371 Date: Oct. 15, 2008

Related U.S. Application Data
(60) Provisional application No. 60/748,347, filed on Dec. 7, 2005.

(51) Int. Cl. C01B 31/36; B32B 5/16

(52) U.S. Cl. 428/402; 423/345

(57) ABSTRACT

Adsorbed gaseous species and elements in a carbon (C) powder and a graphite crucible are reduced by way of a vacuum and an elevated temperature sufficient to cause reduction. A wall and at least one end of an interior of the crucible is lined with C powder purified in the above manner. An Si+C mixture is formed with C powder purified in the above manner and Si powder or granules. The lined crucible is charged with the Si+C mixture. Adsorbed gaseous species and elements are reduced from the Si+C mixture and the crucible by way of a vacuum and an elevated temperature that is sufficient to cause reduction but which does not exceed the melting point of Si. Thereafter, by way of a vacuum and an elevated temperature, the Si+C mixture is caused to react and form polycrystalline SiC.

### BACKGROUND OF THE INVENTION

1. Field of the Invention

The present invention relates to synthesizing polycrystalline ultrahigh-purity (UHP) SiC material useful for growing SiC single crystals to fabricate semiconductor devices for high frequency, high power, high temperature and opto-electronic applications.

2. Description of Related Art

SiC is a semiconductor material that exhibits a unique combination of electrical, chemical and thermo-physical properties that make it extremely attractive and useful for fabricating electronic devices. These properties, which include, without limitation, high breakdown field strength, high operating temperature, good electronic mobility and high thermal conductivity, make possible device operation at significantly higher power, higher temperature and with more resistance to ionizing radiation than comparable devices made from the more conventional semiconductor materials silicon (Si) and GaAs. It has been estimated that transistors fabricated from high resistivity “semi-insulating” SiC will have over five times the power density of comparable GaAs microwave integrated circuits at frequencies up to 10 GHz.

In addition to microwave devices, SiC substrates are used to fabricate power switching devices and diodes whose high voltage and current handling characteristics are five to ten times greater than comparable silicon-based devices, and which are forecasted to reduce significantly the device power losses in utility applications. SiC transistors can operate at temperatures of 400-500° C. versus 100-150° C. for silicon devices making possible electronics for environmentally hostile applications, such as nuclear reactors, aircraft engines, and oil well logging.

Semi-insulating SiC is also a preferred substrate for the growth of GaN-based epitaxial layers, which can be fabricated into microwave transistors and circuits that can operate at even higher microwave frequencies than SiC-based devices. Conductive SiC substrates are used to fabricate GaN-based light-emitting diodes for traffic control, displays, and automotive applications.

To provide optimum device performance, the SiC substrates from which the semiconductor devices are made must exhibit a combination of properties including, without limitation, low defect density, high thermal conductivity, uniform electrical behavior, and the correct resistivity, i.e., either “semi-insulating” for most microwave applications, or conductive for typical power switching and opto-electronic applications.

Those familiar with device technology recognize that minimizing SiC substrate defects such as, without limitation, micropipes, inclusions and grain boundaries, and controlling substrate electrical resistivity are crucial to successful device applications. For example, it has been estimated that resistivities above 50,000 ohm-cm, and preferably over 10⁸ ohm-cm or higher, are needed to achieve superior microwave device performance. For conductive substrates, typical resistivities range from 0.015 to 2 ohm-cm, depending on the application. Resistivity uniformity of ±10% across a substrate is desired but not often achieved. Common to controlling resistivity and its uniformity is the need to minimize the presence of residual, electrically-active impurities in the crystals.

Those skilled in SiC crystal growth and devices recognize that the elimination of defects, which degrade device performance, has been a major challenge of the technology development. Besides optimizing the growth temperature, pressure, and thermal gradient in a SiC crystal growth chamber, increasing the source purity has been a critical parameter for reducing defect formation during SiC crystal growth.

In summary, the production and use of uniform, low-defect, semi-insulating and conductive SiC substrates for device fabrication creates the opportunity for a wide range of improved products including, without limitation, utility power controls, reactor instrumentation, military and commercial radar, communication devices such as cell phones, and efficient solid state lighting. Very high purity SiC source material is a critical enabling technology to achieve an economic, high-yield SiC single crystal growth process for commercial products.

Producing large diameter, electrically uniform, low-defect crystals of silicon and GaAs are well-established commercial processes. However, the development of a reproducible, high-yield production process for SiC semiconductor crystals is still in its development stage. Commercial SiC crystals are produced primarily by the physical vapor transport (PVT) process, or variants thereof. In the PVT process, a polycrystalline (sometimes powder) SiC source material is sublimed at high temperature (2000° C.-2400° C.) in a graphite reactor contained in a suitable vacuum chamber. The sublimed vapor species are transported from the hotter source and condensed on a SiC “seed” maintained at a lower temperature. A SiC single crystal grows by progressive accumulation on the seed and consumption of the source material. The structural and electrical properties of the crystal are mainly controlled by the source properties and by the reactor conditions, i.e., temperature, imposed thermal gradient, and ambient pressure. It will be recognized that other secondary factors can also influence the growth process.

It is well recognized by those skilled in crystal growth in general, and in SiC growth in particular, that the starting material (source purity and form) plays a key role in achieving the desired crystal substrate quality, uniformity, and subsequent device performance characteristics.

Four basic methods have been used to produce silicon carbide material that can potentially serve as a source for crystal growth. None of these methods has yet produced material of optimum purity for SiC semiconductor crystal growth. The methods are:
1. The Acheson Process and its Variations

Perhaps the earliest and most widely used commercial process for SiC synthesis was patented by E. G. Acheson in 1892 (English Patent 18911). In this process, quartz sand (SiO₂) and coke (C) are heated with sawdust and salt in an electric furnace to form a mass of small hard SiC crystals called “carborundum”. The SiC forms by the carbothermic reduction of sand according to the reaction SiO₂+3C→SiC+2CO, and the material is subsequently used as an abrasive. SiC produced this way contains hundreds of parts per million (ppm) of impurities, especially electrically-active boron, nitrogen, and aluminum, and in its massed form the SiC is difficult and expensive to separate into particles sized for crystal growth. Both features make the Acheson prepared material unsuitable as a source material for growth of semiconductor-quality SiC crystals.

Many improvements to the Acheson process have been described since its inception. Since these newer methods produce SiC primarily made to serve non-semiconductor applications, one or more characteristics of the material, such as purity, polytype, and particle size/shape, fail to meet the specifications required for the production of semiconductor-quality SiC crystals (U.S. Pat. No. 4,217,335 (several % impurities, nonstoiciometric); Chinese Patent Publication No. CN 1163859 (low purity); Japanese Patent Publication No. JP 58009807 (low purity); Japanese Patent No. JP 1275416 (low purity, too fine particles); Japanese Patent Publication No. JP 58055322 (low purity); and Japanese Patent Publication No. JP 63147811 (low purity, too fine particles)).
2. Chemical Vapor Deposition.

SiC, normally in the form of layers several millimeters in thickness or as specialized ceramic shapes, is commonly produced by the process of chemical vapor deposition (CVD). In CVD, silicon and carbon-containing chemical compounds (precursors) are heated to form a gas phase rich in silicon and carbon-based molecular species. The silicon and a carbon containing species, generally at temperatures of 1200-1400° C., react to form SiC according to the reaction Si-R1 (g)+C-R2 (g)→SiC+gaseous by-products. Here Si-R1 and C-R2 represent Si and C-bearing compounds, such as silane and propane, respectively, (U.S. Pat. No. 5,704,985). The SiC is usually deposited on a suitable substrate, typically graphite, to form a solid layer, although it is possible to form and collect SiC powder by such reaction schemes. In another variant of CVD, the precursor is a compound containing both Si and C atoms.

Although CVD SiC has been used as a source material for crystal growth, its purity and form are drawbacks to high-yield crystal production. Typical CVD SiC contains 0.7-2 ppm of boron and up to 100 ppm of nitrogen impurities, which adversely affect crystal growth and make it technically difficult to produce semi-insulating SiC by compensation in order to manufacture microwave devices. The solid form means source material for each crystal production run must be laboriously cut to fit the growth reactor leading to increased manufacturing costs. CVD also produces the less desirable beta polytype.
3. Reaction of a Silicon-Containing Compound and a Carbon-Containing Compound in the Solid or Liquid State

SiC can be formed by single or multi-step calcining (heating) reactions in which one reactant is a silicon source and the second is a carbon source. The reaction which may involve solid or liquid components can be illustrated symbolically by Si-R3 (s/1)+C-R4 (s/1)→SiC+by-products where Si-R3 and C-R4 are Si- and C-bearing organic or inorganic compounds distinct from the CVD reactants.

The by-products of the reaction are often gaseous. An illustrative example is described in U.S. Pat. No. 5,863,325, wherein the silicon-containing reactant includes organic (alkoxysilanes) or inorganic (silicon dioxide) compounds, and the carbon-containing reactant is an organic compound containing oxygen (phenol). The reactants in this approach often contain extra undesirable and deleterious chemical species such as water, sulfur, nitrogen and oxygen, or involve the introduction of such unwanted species (for example catalysts) as steps in the complicated reaction process. The reactants themselves often contain 5-20 ppm of impurities. To reduce such impurities, halogen gases are added during reaction, thus increasing the cost and complexity of the method for making SiC powder. Additionally, a “constant stream” of non-oxidizing gas is needed to carry away impurities and by-products, adding further technological complexity and cost. To achieve an optimum particle size, the process steps must be repeated several times and more than one type of furnace is used. Crystals grown from the described SiC powder contain micropipe (penetrating) defect concentrations of 60 to 480 cm⁻² or about 5 to 8 times higher than today's state of the art.

U.S. Pat. No. 4,217,335 is an additional example, in which Si, SiO₂, and C react to form beta SiC with fine (20 μm) particle size. The low source purity, possible oxygen contamination and low process temperatures which limit N removal produce a product lacking the purity, polytype and form optimal for crystal growth.
4. Direct Synthesis of SiC from Elemental Silicon and Carbon

The simplest and most direct method to synthesize SiC is by reaction of its elemental components: C+Si→SiC. However, in the past, it has proven difficult to obtain the exceptionally high-purity levels, the favored polytype and a particle size optimal for the growth of semiconductor-quality SiC crystals when synthesizing SiC this way. The following examples are illustrative of the past difficulties in producing an optimum crystal growth source by this approach.

It is known in the prior art to react generally impure industrial grade (low purity) carbon and silicon to create a beta polytype SiC by reaction at temperatures between 800° C. and 1400° C. in an oxidizing atmosphere for abrasive and ceramic applications. The resulting product has excessively fine particles of beta polytype. These properties are poorly matched to the requirements for crystal growth. In addition, the low purity of the product and its contamination by oxygen would make crystals grown using it as a source unsuitable for semiconductor applications.

U.S. Pat. No. 6,554,897 teaches the formation of SiC from carbon (as a shaped body or powder) and silicon at temperatures between 1500° C. and 2200° C. under a modest vacuum for lighting and sensor applications. Those knowledgeable in the art of SiC synthesis recognize that in this process the C source (lignite or anthracite) is impure, that SiC stoichiometry is difficult to achieve by allowing uncontrolled-Si evaporation, that the process temperatures and moderate vacuum are insufficient to remove N contaminants (indicated by the green color of the resultant product), that in the preferred embodiments the beta polytype is formed, and that the furnace design makes scaling powder production to high volume difficult. These characteristics make the described process unsuitable for the economic production of SiC crystal growth source material.

Another example of SiC synthesis from Si and C is taught by U.S. Pat. No. 6,497,642. Here, the synthesis step is in-situ and followed immediately by the crystal growth process. The low process temperature, need for a specialized form/size of C particle and the limited size of the batch that can be prepared limit the degree of N removal and lead to high processing costs.

Each of these processes produces a material which contains excessive concentrations of electrically-active shallow dopants, inert elements (mostly metals), or deep level dopants, or which is in a form which increases the probability of crystal growth defects, which adversely affects the electrical properties and uniformity, and reduces the yield of usable substrate material.

It would, therefore, be desirable to provide a high-yield manufacturing method to produce ultrahigh-purity silicon carbide polycrystalline material with desired polytype and particle size to grow high-quality SiC single crystals for the fabrication of semiconductor devices that overcomes the above limitations and others.

### SUMMARY OF THE INVENTION

The invention is a method of creating so-called “ultrahigh-purity” (UHP) SiC to distinguish this material from other SiC source material previously reported. UHP SiC created in accordance with the present invention exhibits improved crystalline form, chemical stoichiometry, and a high-purity level so that it overcomes several key limitations of the current SiC synthesis methods. The method employs high-purity Si and carbon reactants, specially purified graphite reactor parts, and a high vacuum, rather than an inert gas ambient, during the SiC synthesis. The high vacuum eliminates the major sources of N contamination, such as growth system leaks, N contamination in the inert gas, N absorbed on the graphite insulation and chamber wall, and also reduces other elemental impurities, such as, Cl, S, Al, etc. The resulting product contains concentrations of electrically-active B, Al, and N well below those reported for any other synthesis process, and very low metal concentrations. Test crystals grown from this SiC source are free of polytypism, inclusions and have low micropipe defect densities. The resistivity of the semi-insulating crystals grown from UHP SiC created in accordance with the present invention is above 10⁹ ohm-cm.

UHP SiC created in accordance with the present invention exhibits the following characteristics: polycrystalline with a particle size between 100-5000 μm; mixture of alpha and beta SiC crystal structure; near stoichiometric in composition; and purity: N<5×10¹⁵ atoms/cm³, B<2×10¹⁵ atoms/cm³, A1<7.3×10¹⁴ atoms/cm³, and all other elements (other than Si and C) below the detection limits of glow discharge mass spectroscopy (GDMS).

The invention comprises the following key features: an innovative low gradient, high-purity and high yield synthesis reactor; the use of ultrapure semiconductor grade Si granules and ultrapure carbon black as starting materials for synthesis; high temperature (>2300° C.) and high vacuum (<10⁻⁵ torr) purification of the carbon powder and graphite synthesis reactor parts; high temperature (>2200° C.) and high vacuum (<10⁻⁵ torr) synthesis of stoichiometrically-premixed Si and carbon powder; and synthesized polycrystalline UHP SiC granules having favored polytypes, size and extremely low impurity levels as noted above.

More specifically, the invention is a method of forming polycrystalline SiC material. The method includes (a) heating carbon (C) powder and a graphite crucible in a vacuum ambient over a period of time at a temperature sufficient to reduce adsorbed gaseous species and elements in the carbon C powder and the graphite crucible, thereby producing purified C powder; (b) following step (a), returning the purified C powder and the graphite crucible to ambient temperature and pressure; (c) following step (b), mixing the purified C powder with silicon (Si) powder or granules to form a Si+C mixture, wherein the amount of purified C powder in said Si+C mixture is at least enough to make said Si+C mixture stoichiometric; (d) following step (b), lining an interior wall of the crucible with the purified C powder; (e) following step (d), charging the lined crucible with the Si+C mixture; (f) heating the Si+C mixture charge and the crucible in a vacuum ambient at a first temperature that does not exceed the melting point of Si but is sufficient to remove adsorbed gaseous species and to reduce contaminant elements from the Si+C mixture; and (g) following step (f), heating the Si+C mixture charge and the crucible in a vacuum ambient at a second temperature sufficient to cause the Si+C mixture to react and form polycrystalline SiC material.

The period of time in step (a) can terminate after the vacuum ambient has decreased to a predetermined pressure.

The mixing of step (c) can occur in an argon gas ambient.

In step (g), the heating can occur for a period of time sufficient for the synthesizing reaction to complete.

The first temperature can be less than the second temperature.

In step (a), the carbon (C) powder and the graphite crucible can be heated in the presence of the vacuum separately.

In step (c), the Si+C mixture can include no more than 20% by weight more C than a stoichiometric mixture of Si+C by weight.

Step (d) can include lining at least one end of the crucible.

The invention is also a method of forming polycrystalline SiC material comprising (a) in the presence of a vacuum, heating carbon (C) powder at a temperature sufficient to reduce adsorbed gaseous species and elements in the carbon (C) powder, while drawing a vacuum thereon until the vacuum pressure decreases to a desired extent, thereby producing purified C powder; (b) in the presence of a vacuum, heating a graphite crucible at a temperature sufficient to reduce adsorbed gaseous species and elements in the crucible, while drawing a vacuum thereon until the vacuum pressure decreases to a desired extent; (c) lining at least a portion of an interior of the crucible with C powder purified in the manner of step (a); (d) forming an Si+C mixture utilizing C powder purified in the manner of step (a) and Si powder or granules; (e) charging the lined crucible with the Si+C mixture; (f) in the presence of a vacuum, heating the lined crucible and the Si+C mixture charge therein at a first temperature that does not exceed the melting point of Si but is sufficient to reduce adsorbed gaseous species and elements from (1) the Si+C mixture and (2) the crucible, while drawing a vacuum thereon until the pressure of the vacuum pressure decreases to a desired extent; and (g) following step (f), heating the lined crucible and the Si+C mixture charge therein in the presence of a vacuum at a second temperature sufficient to cause the Si+C mixture to react and form polycrystalline SiC material.

The vacuum sufficient to reduce adsorbed gaseous species and elements in at least one of step (a), step (b) and step (f) can be less than 10⁻⁴ torr. The desired extent of the vacuum pressure in at least one of step (a), step (b) and step (f) can be less than 10⁻⁵ torr. The vacuum in step (g) can be less than 10⁻⁵ torr.

Step (d) can occur in the presence of an inert gas, such as Argon.

The temperature in step (a) can be about 2350° C. The temperature in step (b) can be about 2350° C. The temperature in step (f) can be about 1200° C. The temperature in step (g) can be about 2250° C.

The Si+C mixture can include no more than 20% by weight more C than a stoichiometric mixture of Si+C by weight.

Step (c) can include lining the walls and at least one end of the crucible.

Lastly, the invention is a method of forming polycrystalline SiC material that comprises (a) reducing adsorbed gaseous species and elements in a carbon (C) powder by way of a vacuum and an elevated temperature sufficient to cause said reduction, thereby producing purified C powder; (b) reducing adsorbed gaseous species and elements in a graphite crucible by way of a vacuum and an elevated temperature sufficient to cause said reduction; (c) lining a wall and at least one end of an interior of the crucible with C powder purified in the manner of step (a); (d) forming an Si+C mixture with C powder purified in the manner of step (a) and Si powder or granules; (e) charging the lined crucible with the Si+C mixture; (f) reducing adsorbed gaseous species and elements from (1) the Si+C mixture and (2) the crucible by way of a vacuum and an elevated temperature that is sufficient to cause said reduction but which does not exceed the melting point of Si; (g) following step (f), causing the Si+C mixture to react and form polycrystalline SiC material by way of a vacuum and an elevated temperature that is sufficient to cause said reaction.

The C powder of at least one of step (c) and step (d) can be the purified C powder of step (a).

Step (d) can occur in the presence of an inert gas, such as Argon.

### BRIEF DESCRIPTION OF THE DRAWING

FIG. 1 is a schematic cross-sectional view of an apparatus for producing ultrahigh-purity polycrystalline carbide (SiC) in accordance with the present invention.

### DETAILED DESCRIPTION OF THE INVENTION

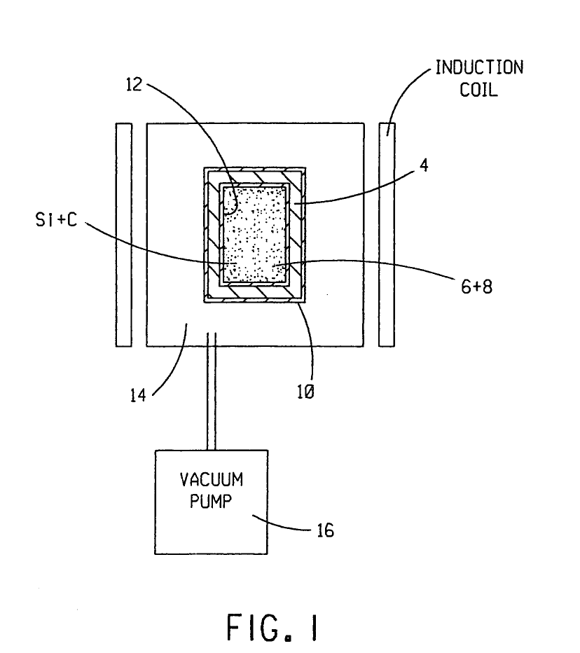

With reference to FIG. 1, the invention is a method of producing ultrahigh-purity polycrystalline silicon carbide (SiC) that is carried out in an apparatus 2 that includes a closed graphite crucible 4 for containing premixed silicon (Si) powder or granules 6 and carbon (C) powder . The graphite crucible 4 is also used as a susceptor to heat the mixture. Graphite fiber in a rigid foam surrounding the crucible is used as an external thermal insulation 10. A purified carbon powder liner 12 inside the crucible is used as 1) an internal layer of thermal insulation to reduce temperature gradient and 2) a diffusion barrier to prevent silicon from reacting with the crucible wall which helps to minimize contamination of the SiC product material by crucible impurities during the synthesis process.

### Example 1

In an exemplary, non-limiting implementation of the invention, high-purity carbon (C) black powder and semiconductor grade silicon (Si) powder or granules are chosen for the starting materials. Non-limiting examples of suitable high-purity C black powders include THERMAX® and THERMAX ULTRA-PURE® carbon black, both available from Cancarb Limited Corporation, P.O. Box 310, Medicine Hat, Alberta Canada T1A7G1. In the U.S., THERMAX® and THERMAX ULTRA-PURE® are registered trademarks of Cancarb Limited Corporation, U.S. Trademark registration numbers 1,561,698 and 1,526,307, respectively.

The crucible 4 is formed from high-purity graphite, such as, without limitation, Grade SiC-6 Isotropic Graphite available from Toyo Tanso USA, Inc. of 2575 NW Graham Circle, Troutdale, Oreg. 97060. In one exemplary, non-limiting embodiment, the crucible 4 has an outer diameter of 6 inches, a height of 9 inches, a wall thickness of 0.5 inch and a threaded graphite cap (not shown) configured to threadedly engage mating threads formed on the side of the crucible 4 adjacent an end thereof. Rigid carbon fiber was used as the thermal insulation 10.

Initially, the high-purity C powder 8, the graphite crucible 4 and the graphite fiber used as the external thermal insulation 10 are baked, desirably simultaneously, at high temperature in a vacuum ambient to reduce adsorbed gaseous species and all metallic and non-metallic elements therein, thereby producing purified C powder 8, a desorbed graphite crucible 4 and desorbed graphite fiber thermal insulation 10. In one exemplary, non-limiting embodiment, the high-purity C powder 8, the graphite crucible 4 and the graphite fiber thermal insulation 10 are heated to a temperature of approximately 2350° C. in a vacuum ambient supplied by a suitable vacuum pump.

At the beginning of this heated reduction step, a large number of adsorbed gaseous species and elements being released into the vacuum ambient prevented the vacuum ambient from achieving so-called high vacuum. However, the vacuum pump acting on the vacuum ambient over time continues to release or reduce the adsorbed gaseous species and elements present in the high-purity C powder 8, the graphite crucible 4 and the graphite fiber thermal insulation 10. As a result, the pressure of the vacuum ambient decreases over time to a suitable and/or desirable high vacuum, e.g., between 10⁻⁵ and 10⁻⁷ torr, whereupon the reduction of the high-purity C powder 8, the graphite crucible 4 and the graphite fiber thermal insulation 10 can be deemed to be complete, and the respective purified C powder 8, desorbed graphite crucible 4 and desorbed graphite fiber thermal insulation 10 formed.

Once formed, the purified C powder 8, the desorbed graphite crucible 4 and the desorbed graphite fiber thermal insulation 10 are allowed to return to room temperature and pressure for further processing.

The Si powder or granules 6 and the purified C powder 8 are then mixed thoroughly at or about room temperature in a gaseous argon (Ar) ambient to form a Si+C mixture (6+8). This Si+C mixture (6+8) contains no less than a stoichiometric ratio of Si powder or granules 6 and purified C powder 8, and desirably includes 10%-20% more purified C powder (by weight) 8 than required to form a stoichiometric ratio of Si powder or granules and purified C powder 8. For example, suppose an exemplary stoichiometric ratio of Si+C mixture includes 2400 g of Si powder or granules 6 and 1050 g of purified C powder 8. In order for the Si+C mixture (6+8) to have 10%-20% more purified C powder (by weight) than required to form a stoichiometric ratio of Si powder or granules 6 and purified C powder 8, the 2400 g of Si powder or granules 6 would be mixed with between 1155 g and 1260 g of purified C powder 8.

The inside wall of the desorbed crucible 4 is lined with the purified C powder 8 in any suitable or desirable manner, such as via a ball mill drive, to form liner 12. In an exemplary, non-limiting embodiment, the thickness of this lining is about 2-5 mm. However, this thickness is not to be construed as limiting the invention since it is envisioned that other thicknesses may also be acceptable.

If desired, one or more layers of purified C powder 8 may be deposited between the Si+C mixture (6+8) and one or both ends (or end caps) of the desorbed crucible 4 to separate the Si+C mixture (6+8) from said end(s) (or end cap(s)). However, this is not to be construed as limiting the invention.

The desorbed crucible 4 lined with the purified C powder 8 that forms liner 12 is then charged with the Si+C mixture (6+8). Any leftover or empty space in the desorbed crucible 4 may be filled with additional purified C powder 8. The purified C powder surrounding the Si+C mixture (6+8) functions as 1) a thermal insulation to reduce temperature gradient inside the crucible 4, 2) a diffusion barrier to prevent Si from reacting with the inside wall of the crucible 4 and transporting to the top cap, and 3) a barrier to minimize the transport of impurities from the desorbed crucible 4 to the reactants and so maintain the purity of the reacted SiC.

The combination of the desorbed crucible 4 including the Si+C mixture (6+8) charge therein and the desorbed graphite fiber thermal insulation 10 is positioned in a processing chamber 14 wherein the charge of the Si+C mixture (6+8) is heated, desirably by induction heating the desorbed crucible 4, to a temperature of approximately 1200° C. (below the melting point of Si) for a first interval of time in the presence of a first high vacuum (<10⁻⁴ torr) ambient supplied by a vacuum pump 16 coupled to chamber 14 to reduce or remove adsorbed gaseous species from the Si+C mixture (6+8) inside of crucible 4 and to further reduce contaminant elements. (Because gas can easily pass through graphite, the application of a vacuum on chamber 14 by vacuum pump 16 draws gaseous species from the Si+C (6+8) mixture inside of crucible 4, which is made of graphite.)

The first interval of time can be a predetermined interval of time, e.g., approximately 12 hours, or can be an interval of time that commences at a time related to the start of this heating step and which terminates when the vacuum pump 16 acting on the ambient inside chamber 14 is capable of causing the vacuum ambient therein and, hence, inside of crucible 4 to achieve a desired low pressure, e.g., <10⁻⁵ torr, that indicates that adsorbed gaseous species have been reduced or removed from the Si+C mixture (6+8) to a desired extent.

After heating the Si+C mixture (6+8) at the first temperature in the first high vacuum ambient for the first interval of time, the Si+C mixture (6+8) is heated (the temperature is increased) to a second temperature of approximately 2250° C. in the presence of a second high vacuum (<10⁻⁵ torr) ambient supplied by vacuum pump 16 coupled to chamber 14 for approximately 1-2 hours, whereupon the Si 6 and C 8 react to form ultrahigh-purity alpha, beta-type SiC crystallites, hereinafter referred to as “polycrystalline SiC material”. The high vacuum synthesis ambient substantially reduces the contamination of nitrogen (N) formed in the polycrystalline SiC material.

Thereafter, the polycrystalline SiC material, the crucible 4 and the graphite fiber thermal insulation 10 are allowed to return to room temperature in the presence of high vacuum (<10⁻⁴ torr). Once at room temperature, the polycrystalline SiC material can be removed from crucible 4 for subsequent use thereof to grow SiC crystals that can be used to fabricate semiconductor devices.

The resulting polycrystalline SiC material exhibits ultrahigh-purity, as verified by glow discharge mass spectroscopy (GDMS). In an exemplary polycrystalline SiC material made in the manner described above, except for sulfur having a concentration of approximately 3.0×10¹⁵ atoms/cm³, and aluminum having a concentration of approximately 1.4×10¹⁵ atoms/cm³ that were occasionally detected by GDMS, all the other impurities were below the GDMS detection limit, especially the concentration of electrically-active boron (B) that was reduced to below 1.8×10¹⁵ atoms/cm³. The concentration of electrically-active nitrogen (N) was also reduced to below 5×10¹⁵ atoms/cm³, as measured indirectly by secondary ion mass spectroscopy (SIMS) from SiC crystals grown using the synthesized polycrystalline SiC material.

The above-described method of forming polycrystalline SiC material exhibits the following benefits over prior art methods: a highly uniform silicon-carbon reaction, a substantial reduction of Si reaction with the wall of the crucible/susceptor over prior art methods, and the reduction or elimination of the unwanted transport of SiC to the end cap during synthesis of the polycrystalline SiC material.

The present invention has been described with reference to the preferred embodiments. Obvious modifications and alterations will occur to those of ordinary skill in the art upon reading and understanding the preceding detailed description. It is intended that the invention be construed as including all such modifications and alterations insofar as they come within the scope of the appended claims or the equivalents thereof.

The invention claimed is:

1. A method of forming polycrystalline SiC material comprising:
(a) heating carbon (C) powder and a graphite crucible in a vacuum ambient over a period of time at a temperature sufficient to reduce adsorbed gaseous species and elements in the carbon (C) powder and the graphite crucible, thereby producing purified C powder;
(b) following step (a), returning the purified C powder and the graphite crucible to ambient temperature and pressure;
(c) following step (b), mixing the purified C powder with silicon (Si) powder or granules to form a Si+C mixture, wherein the amount of purified C powder in said Si+C mixture is at least enough to make said Si+C mixture stoichiometric;
(d) following step (b), lining an interior wall of the crucible with the purified C powder;
(e) following step (d), charging the lined crucible with the Si+C mixture;
(f) heating the Si+C mixture charge and the crucible in a vacuum ambient at a first temperature that does not exceed the melting point of Si but is sufficient to remove adsorbed gaseous species and to reduce contaminant elements from the Si+C mixture; and
(g) following step (f), heating the Si+C mixture charge and the crucible in a vacuum ambient at a second temperature sufficient to cause the Si+C mixture to react and form polycrystalline SiC material.

2. The method of claim 1, wherein the period of time in step (a) terminates after the vacuum ambient has decreased to a predetermined pressure.

3. The method of claim 1, wherein the mixing of step (c) occurs in an argon gas ambient.

4. The method of claim 1, wherein, in step (g), said heating occurs for a period of time sufficient for the synthesizing reaction to complete.

5. The method of claim 1, wherein the first temperature is less than the second temperature.

6. The method of claim 1, wherein, in step (a), the carbon (C) powder and the graphite crucible are heated in the presence of the vacuum separately.

7. The method of claim 1, wherein, in step (c), the Si+C mixture includes no more than 20% by weight more C than a stoichiometric mixture of Si+C by weight.

8. The method of claim 1, wherein step (d) includes lining at least one end of the crucible.

9. A method of forming polycrystalline SiC material comprising:
(a) in the presence of a vacuum, heating carbon (C) powder at a temperature sufficient to reduce adsorbed gaseous species and elements in the carbon (C) powder, while drawing a vacuum thereon until the vacuum pressure decreases to a desired extent, thereby producing purified C powder;
(b) in the presence of a vacuum, heating a graphite crucible at a temperature sufficient to reduce adsorbed gaseous species and elements in the crucible, while drawing a vacuum thereon until the vacuum pressure decreases to a desired extent;
(c) lining at least a portion of an interior of the crucible with C powder purified in the manner of step (a);
(d) forming an Si+C mixture utilizing C powder purified in the manner of step (a) and Si powder or granules;
(e) charging the lined crucible with the Si+C mixture;
(f) in the presence of a vacuum, heating the lined crucible and the Si +C mixture charge therein at a first temperature that does not exceed the melting point of Si but is sufficient to reduce adsorbed gaseous species and elements from (1) the Si+C mixture and (2) the crucible, while drawing a vacuum thereon until the pressure of the vacuum pressure decreases to a desired extent; and
(g) following step (f), heating the lined crucible and the Si+C mixture charge therein in the presence of a vacuum at a second temperature sufficient to cause the Si +C mixture to react and form polycrystalline SiC material.

10. The method of claim 9, wherein, at least one of the following:
the vacuum sufficient to reduce adsorbed gaseous species and elements in at least one of step (a), step (b) and step (f) is <10⁻⁴ torr;
the desired extent of the vacuum pressure in at least one of step (a), step (b) and step (f) is <10⁻⁵ torr; and
the vacuum in step (g) is <10⁻⁵ torr.

11. The method of claim 9, wherein step (d) occurs in the presence of an inert gas.

12. The method of claim 11, wherein the inert gas is Argon.

13. The method of claim 9, wherein, at least one of:
the temperature in step (a) is about 2350° C.;
the temperature in step (b) is about 2350° C.;
the temperature in step (f) is about 1200° C.; and
the temperature in step (g) is about 2250° C.

14. The method of claim 9, wherein the Si+C mixture includes no more than 20% by weight more C than a stoichiometric mixture of Si+C by weight.

15. The method of claim 9, wherein step (c) includes lining the walls and at least one end of the crucible.

16. A method of forming polycrystalline SiC material comprising:
(a) reducing adsorbed gaseous species and elements in a carbon (C) powder by way of a vacuum and an elevated temperature sufficient to cause said reduction, thereby producing purified C powder;
(b) reducing adsorbed gaseous species and elements in a graphite crucible by way of a vacuum and an elevated temperature sufficient to cause said reduction;
(c) lining a wall and at least one end of an interior of the crucible with C powder purified in the manner of step (a);
(d) forming an Si+C mixture with C powder purified in the manner of step (a) and Si powder or granules;
(e) charging the lined crucible with the Si+C mixture;
(f) reducing adsorbed gaseous species and elements from (1) the Si+C mixture and (2) the crucible by way of a vacuum and an elevated temperature that is sufficient to cause said reduction but which does not exceed the melting point of Si; and
(g) following step (f), causing the Si+C mixture to react and form polycrystalline SiC material by way of a vacuum and an elevated temperature that is sufficient to cause said reaction.

17. The method of claim 16, wherein the C powder of at least one of step (c) and step (d) is the purified C powder of step (a).

18. The method of claim 16, wherein step (d) occurs in the presence of an inert gas.

19. The method of claim 16, wherein, at least one of:
the elevated temperature in step (a) is about 2350° C.;
the elevated temperature in step (b) is about 2350° C.;
the elevated temperature in step (f) is about 1200° C.; and
the elevated temperature in step (g) is about 2250° C.

20. The method of claim 16, wherein, at least one of the following:
the vacuum in at least one of step (a), step (b) and step (f) is less than either 10⁻⁴ or 10⁻⁵ torr; and
the vacuum in step (g) is less than 10⁻⁵ torr.

21. A polycrystalline SiC material comprising:
particle size between 100-5000 μm;
a mixture of alpha and beta SiC structures;
a near stoichiometric mixture of Si and C;
a concentration of nitrogen <5×10¹⁵ atoms/cm³;
a concentration of boron <2×10¹⁵ atoms/cm³; and
a concentration of aluminum <7.3×10¹⁴ atoms/cm³.
